(19) United States
(12) Patent Application Publication
(10) Pub. No.: US 2004/0195847 A1
(43) Pub. Date: Oct. 7, 2004

(54) Doorknob tool

(76) Inventor: Frank C. Cali, Chicago, IL (US)

Correspondence Address: Paul H. Gallagher, 2439 Jackson Ave, Evanston, IL, 60201, US

(21) Appl. No.: 10/403,698

(22) Filed: Apr. 1, 2003

(51) Int. Cl. B25J 1/00

(52) U.S. Cl. 294/1.1

(57) ABSTRACT

A tool similar in shape to a question mark, having a bow at one end forming a notch, at one end and a handle at the other end. The notch fits over the doorknob, and the user swings the handle and thereby turns the doorknob.

### FIELD OF THE INVENTION

The invention has to do with a device for facilitating the turning of a doorknob and particularly for a user who is troubled with arthritis in the hands, which makes it more difficult to manipulate the doorknob. As is generally known, in gripping a doorknob with the hand, the fingers must be bent at least partially around the doorknob; and users with arthritis find it very difficult to grip and turn the doorknob in many cases.

### OBJECTS OF THE INVENTION

A main object is to provide a tool which is applied to the doorknob by the user and utilized in turning the doorknob.

A more particular object is to provide such a doorknob tool having the following features and advantages:

1. It is extremely simple and easily handled by a user.

2. It can be very easily applied to a doorknob.

3. It is very inexpensive, both in materials used and in the steps of fabrication of the device.

4. It has an extension which serves as a handle for easy manipulation by a user.

5. It can be effectively applied to doorknobs of different sizes.

6. The device when on the doorknob, and actuated for turning it, tightens against the doorknob and grips it firmly as a direct result of the user's applying pressure to it.

### BRIEF DESCRIPTIONS OF THE INDIVIDUAL FIGURES OF THE DRAWINGS

FIG. 1 is a perspective view of one form of the tool.

FIG. 2 is a side view of the device applied to the doorknob.

FIG. 3 is an end view of a doorknob of a common shape that is not exactly circular in shape.

FIG. 4 is a view of the tool applied to a doorknob and including a dotted line arc indicating the depth of an edge of a doorknob extending into the material of the tool itself.

FIG. 5 is a sectional view of a tool of different construction from that of FIG. 1.

FIG. 6 is a top view of a tool of different construction from that of FIG. 1.

FIG. 7 is a side view taken at line 7-7 of FIG. 6 and showing a segment in open position.

FIG. 8 is a top view oriented according FIG. 6 of a different form of tool, and showing a segment in open position.

FIG. 9 is a side view taken at line 9-9 of FIG. 8.

FIG. 10 is a side view of a different form of device, made up of separable parts and showing the parts separated a small extent.

FIG. 11 is a side view of another form of device, similar to that of FIG. 10 and showing the parts separated a small extent.

FIG. 12 is a side view of a device similar to those of FIGS. 10 and 11.

FIG. 13 shows a device similar to that of FIG. 1.

FIG. 14 is a view taken at line 14-14 of FIG. 13.

FIG. 15 is a side view of still another form that includes a liner of different material for gripping the doorknob.

FIG. 16 is a side view of another form having an element of resilient material for gripping the doorknob.

FIG. 17 is a sectional view taken at line 17-17 of FIG. 16.

### DETAILED DESCRIPTION OF THE DRAWINGS

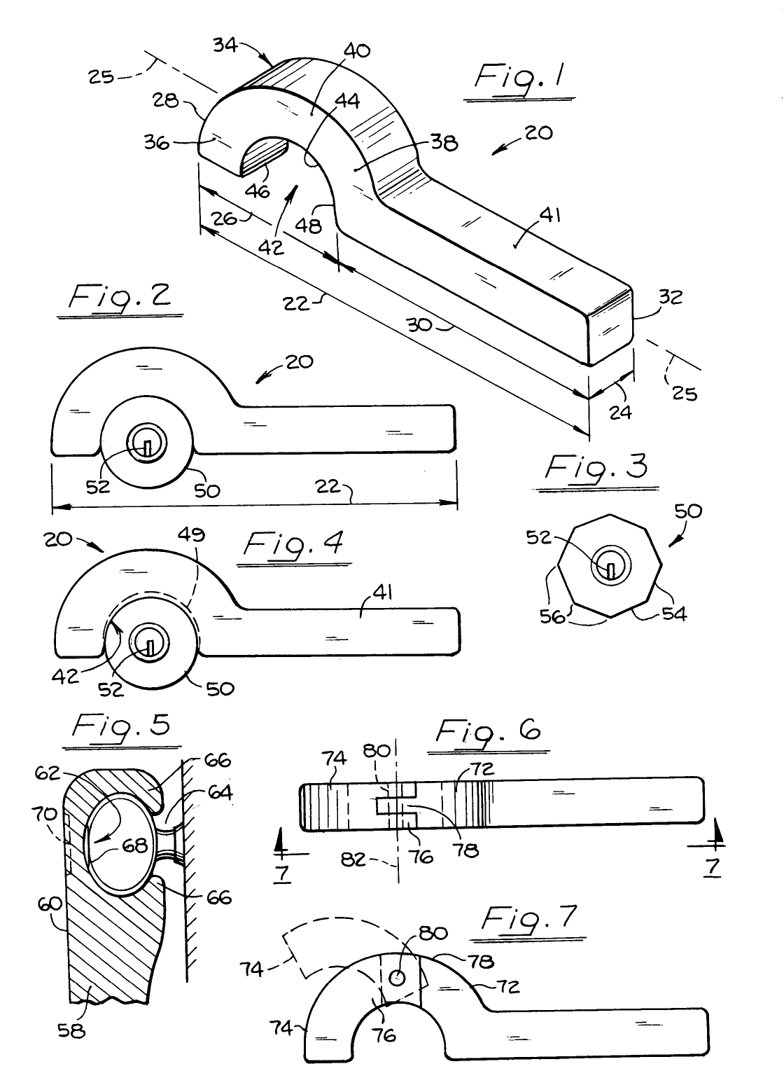

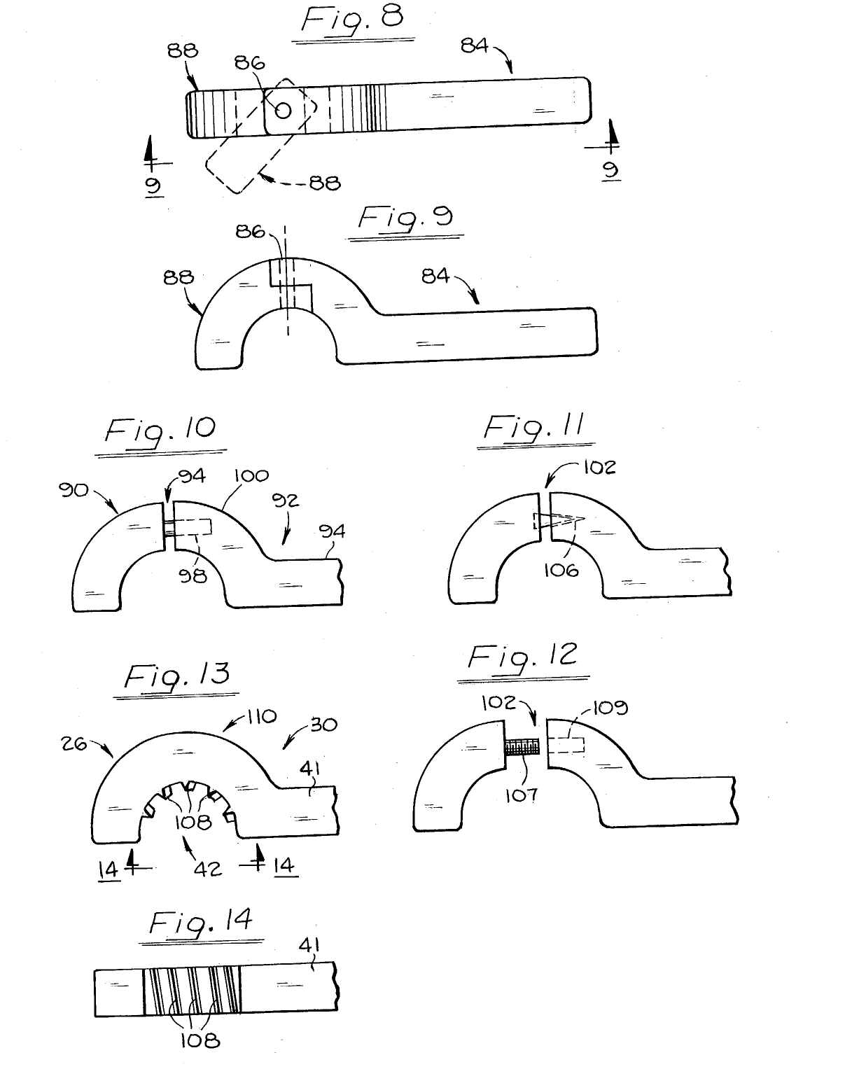

FIG. 1 shows a preferred form of the device and in the description of FIG. 1, attention may be also applied to FIG. 2 which shows the same device in side view, but applied to the doorknob.

The device of FIGS. 1 and 2 indicated at 20 has a longitudinal dimension 22 and a width dimension 24. A central longitudinal axis 25 is shown for convenience in reference.

The device 20 is a single piece, integral construction made up of a plastic material such as styrofoam and is of such character as to be capable of being produced by molding. The plastic material mentioned is relatively rigid so as to easily maintain its shape, and to so retain its shape against substantial pressures, but does posses a limited degree of flexibility, so as to flex in certain areas, under greater pressure applied externally. This results in a certain reduction in dimensions so as to apply pressure on the doorknob with consequent greater gripping action.

The device 20 includes a front portion 26, forming a front end 28 and a rear portion 30 forming a rear end 32.

The front end portion 26 is made up of a bow 34 which includes front and rear elements 36, 38 extending generally transversely from one side of the axis 25, i.e., above the axis when the device is in use, which are interconnected by a longitudinal piece 40. The rear portion 30 forms a longitudinally straight handle 41 and the rear element 38 and the handle together at their juncture form an element 43 which is relatively thick and large to better withstand forces produced in leveraging the handle.

The bow 34 forms a notch 42 opening through the edge of the device opposite the bow and having an inner surface 44 of substantially circular shape, with front and rear surfaces 46, 48. The device is shaped and dimensioned for use on doorknobs of very common size and shape, i.e., most doorknobs in houses or homes are made of nearly a common size and shape. The tool is applied to the doorknob, by positioning the notch opening downwardly and fitted over the knob. The dimension between the side surfaces 46, 48 is slightly less than the diameter of most doorknobs and those surfaces grip the doorknob throughout at least half of the doorknob, and slightly more, due to the slight yielding of the surfaces of the notch. FIG. 4 shows a dotted line arc 49 which in this view indicates the edge of the doorknob which penetrates into the material of the tool. FIG. 4 shows this dimension rather exaggerated, but the purpose of the arrangement is that a complete gripping action against the doorknobs of different sizes is provided.

As will be observed from the foregoing, the user grasps the tool adjacent the midportion thereof and fits it on the doorknob. In this step, the user need not bend his fingers to any material extent, and the tool can be easily applied. Thereafter, to turn the knob, he pushes downwardly on the handle 41, and the material making up the bow flexes and produces a greater gripping effect against the doorknob.

FIGS. 2 and 4 show the tool so applied to the doorknob 50, which has a keyhole 52. It will be noted that the notch 42 is open throughout the transverse extent of the tool.

FIG. 3 shows a bare doorknob of conventional kind, on the periphery of which are flat or tangential surfaces 54, between adjacent ones of which are projections 56. As noted, this is a common form of doorknob which is roughened for providing greater gripping action by the hand. This same roughened surface is thus utilized in connection with the use of the tool.

FIG. 5 is a longitudinal sectional view of a different construction of tool. This tool has a handle 58 corresponding with the handle 41 and a bow 60. In the present case bow 60 forms a notch 62 which has an opening 64 on only one side, resulting in a ridge 66 surrounding the notch. The notch 64 is of lesser diameter than the knob, and the notch inwardly of the opening 64, is of concave shape in cross section to grip the doorknob over a greater area.

In applying the device of FIG. 5, the opening 64 is directed toward the doorknob and the upper edge 66 is flexed over the doorknob and then released and the two elements 66 tightly grip the doorknob. A keyhole in the knob is shown at 68 and the tool is provided with a slit 70 for accommodating a key for the doorknob.

FIGS. 6 and 7 show a modified form relative to that of FIG. 1. In this case, the bow, or front portion, is made up of two pieces 72, 74 having interengaging elements 76, 78, and a pin 80 extended through the elements 76, 78 to provide a pivoting action on a transverse axis 82. This enables the front segment 74 to swing upwardly (FIG. 7) to provide a wider access opening to the notch in applying the tool to the doorknob.

FIGS. 8 and 9 show a tool 84 made up of two parts hingedly connected together by a pin 86 on a vertical axis, to enable the front portion 88 to be swung out of alignment with the main part of the tool. This effectively provides a wider notch to facilitate placement of the tool on the knob, and after an initial step in so placing it, the front portion 88 is swung back to its normal longitudinal position.

FIG. 10 shows still another form of tool wherein the tool is made up of a front portion 90 and a rear portion 92 which includes a handle 94. In this case the bow 96 is shaped similarly to that of FIGS. 1, 2 but is separated as indicated at 94. On one of the segments, e.g., front segment, is a pin 98 extending into a cooperating hole 100, and preferably glued. This provides a limited degree of flexibility between the front and rear segments.

FIG. 11 shows still a different construction, in which the front portion is separated into two segments as indicated at 102. On one of the segments, e.g., front segment, is provided a conical pin 104 which is positioned in a hole 106 of complementary shape in the other segment. This arrangement also provides an additional, though limited, degree of flexibility.

The tool of FIG. 12 differs from that of FIG. 11 in having a threaded pin 107 and a tapped hole 109.

Another form of notch surface is shown in FIGS. 13 & 14. The notch surface is provided with spaced embossments 108, preferably in the form of ribs extending transversely of the notch 110, and in spiraling direction. These ribs provide a much greater gripping effect, and it is to be noted that they are formed in the same operation as in producing the tool itself, i.e., in a molding operation.

FIG. 15 shows an additional detail of construction that may be utilized in making the tool. This figure shows the tool 20 of FIGS. 1 and 2, and the notch 42. If desired, the surface of the notch may be provided with a liner 112 adhered to the surface of the notch in a suitable manner. Such a liner may be made up of any of the following: rubber, cloth, including canvas, plastic, metal. The liner and the surface of the notch interengage throughout a great area, relative to the dimensions of the two, and accordingly the liner will be held in proper place despite great pressures tending to dislodge the tool or even the liner itself.

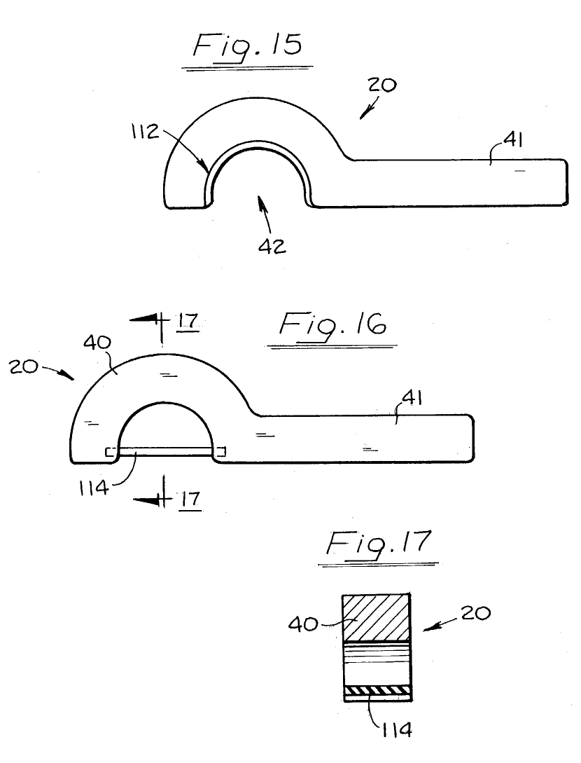

FIGS. 16 and 17 show a tool 20 similar to that of FIGS. 1 and 2, but differs in the inclusion of a resilient ( e.g., rubber) piece 114 extending longitudinally across the open side of the notch, and with its ends embedded in the material of the main body of the tool.

This rubber piece works with the surface of the notch itself in gripping the doorknob.

1. A doorknob tool comprising,
an elongated piece having a front end portion forming a front end and a rear end portion forming a rear end and having a longitudinal reference axis,
the tool including a bow at the front end having front and rear segments extending laterally from said axis and interconnected at their outer ends by a longitudinal segment,
the bow defining a notch opening on the side of the axis opposite said longitudinal segment,
the notch having an inner surface extending a substantial dimension transversely of the tool, and
the tool is made up of material that is generally rigid but having a limited degree of flexibility.

2. A doorknob tool according to claim 1 wherein, it is made up of a single, integral, one-piece construction.

3. A doorknob tool according to claim 2 wherein,
it has opposite side surfaces of planar shape parallel and spaced apart to form uniform thickness of the tool throughout its length.

4. A doorknob tool according to claim 3 wherein the material of the tool is styrofoam.

5. A doorknob tool according to claim 1 wherein,
the bow is made up of two parts pivoted together about a vertical axis perpendicular to the reference axis when the tool is in position of use.

6. A doorknob tool according to claim 1 wherein,
the bow is made up of two parts pivoted together about a horizontal axis perpendicular to the reference axis when the tool is in position of use.

7. A doorknob tool according to claim 1 wherein,
the bow is made up of two parts on longitudinally opposite sides of a plane transverse to the reference axis, and
the two parts of the bow are secured together by a pin extending parallel with the reference axis.

8. A doorknob tool according to claim 7 wherein,
the pin is formed as an integral element of one of the parts of the bow and glued to the other part of the bow.

9. A doorknob tool according to claim 8 wherein,
the pin is conical in shape,
the base of the pin is embedded in the front part of the bow, and
the apex of the pin is extended into a complementary hole in the rear part of the bow.

10. A doorknob tool according to claim 7 wherein,
the pin is substantially cylindrical, and
the rear part of the bow has a tapped hole operably receiving the pin.

11. A doorknob tool according to claim 2 wherein,
the notch opens through only one side of the tool and has a side opening surrounded by material of the tool,
the notch thereby having an inner surface engaging and surrounding the periphal surface of the doorknob when the tool is in position of use.

12. A doorknob tool according to claim 1 wherein,
the notch has only the material of the body of the tool forming its inner exposes surface.

13. A doorknob tool according to claim 12 wherein,
the inner exposed surface of the notch is formed by a generally broad surface without substantially raises or leprocies.

14. A doorknob tool according to claim 12 wherein,
the inner exposed surface of the notch is provided with ribs having a substantial dimension transversely of the tool and axial of the notch.

15. A doorknob tool according to claim 1 wherein,
the notch is provided with a liner of flexible frictional material separate from the material of the body of the tool itself.

16. A doorknob tool according to claim 1 wherein,
the body of the tool, without any elements separate therefrom, forms a notch with a side opening, and
the tool includes a strip of flexible, elastic material extended across the open side of the notch with the ends thereof embedded in the body of the tool,
said strip and the surface of the notch cooperating in entirely surrounding the doorknob in gripping relation when the tool is in position of use.
